(19) United States
(12) Patent Application Publication
(10) Pub. No.: US 2009/0239534 A1
(43) Pub. Date: Sep. 24, 2009

(54) APPARATUS AND A SYSTEM FOR REGISTERING PROFILE INFORMATION OF A TERMINAL

(76) Inventors: Hee Jin Jang, Yongin-si (KR); Su Won Lee, Seongnam-si (KR)

Correspondence Address: MCNEELY BODENDORF LLP, P.O. BOX 34175, WASHINGTON, DC, 20043, US

(21) Appl. No.: 12/178,822

(22) Filed: Jul. 24, 2008

(30) Foreign Application Priority Data
Mar. 19, 2008 (KR) 10-2008-0025356

(51) Int. Cl. H04Q 7/20

(52) U.S. Cl. 455/435.1

(57) ABSTRACT

An apparatus and system for registering profile information of a terminal in a network is provided. A profile information agent includes a receiver which receives a profile information transmission request message containing profile information associated with a terminal and a transmitter which transmits a profile information registration request message to a profile information server, the profile information registration request message including the profile information.

### CROSS-REFERENCE TO RELATED APPLICATION

This application claims the benefit under 35 U.S.C. §119(a) of a Korean Patent Application No. 10-2008-00025356, filed on Mar. 19, 2008, in the Korean Intellectual Property Office, the entire disclosure of which is incorporated herein by reference.

### TECHNICAL FIELD

The following description relates to a mobile communication system, and more particularly, to an apparatus and a system for registering profile information of a terminal in a network.

### BACKGROUND

Generally, where a terminal accesses a network to transmit or receive data, the network my need to be aware of various types of information associated with the terminal, such as authentication information, charge information, and the like.

As an illustration only, in addition to an existing mobile phone, a personal digital assistant (PDA), Ultra-Mobile PC (UMPC), and the like may also access the network as a terminal. With the increasing types of services available via the network, terminal information the network may need to be aware has also been increasing.

For example, a Subscriber Identity Module (SIM) has been generalized in European countries and has been introduced to network accessible terminals so that a user may access the network with various types of terminals in turn. Accordingly, terminal information, that is, information regarding a terminal, may be dynamically changed.

As various types of wireless networks such as wireless broadband (WiBro), wireless local area network (WLAN), High-Speed Downlink Packet Access (HSDPA), and the like are generalized and readily available, the same terminal may access a plurality of wireless networks. Accordingly, each network may need to be aware of information associated with a current network being accessed by the terminal, location information of the terminal, and the like.

In a conventional art, access to authentication information, charge information, and the like was allowed for only a provider operating a corresponding network. A user of a terminal or the terminal was not allowed to access the information. Accordingly, where terminal information changed, it was difficult to immediately update the terminal information.

Accordingly, there is a need for a method, apparatus and system that registers profile information of a terminal.

### SUMMARY

In one general aspect, there is provided a method, apparatus and system that registers or updates profile information of a terminal in a network.

In another general aspect, a profile information agent includes a receiver which receives a profile information transmission request message containing profile information associated with a terminal, and a transmitter which transmits a profile information registration request message to a profile information server, the profile information registration request message including the profile information, wherein the receiver receives a profile information registration response message from the profile information server corresponding to the profile information registration request message.

The profile information may comprise at least one of authentication information associated with the terminal, charge information, Quality of Service (QoS) information, communication network information associated with a network of the terminal, and service preference information.

The transmitter may transmit a profile information transmission confirm message to the terminal corresponding to the profile information registration response message.

The receiver may receive the profile information transmission request message using a cryptographic protocol. The cryptographic protocol may be an Internet Protocol Security (IPSec) protocol.

The transmitter may transmit the profile information registration request message using a cryptographic protocol. The cryptographic protocol may use a cryptographic key.

In still another general aspect, a gateway includes a transmitter which transmits, to a profile information agent, a profile information transmission request message containing profile information associated with a terminal, and a receiver which receives a profile information transmission confirm message from the profile information agent corresponding to the profile information transmission request message.

In yet another general aspect, a network access server includes a transmitter which transmits, to a profile information server, a profile information registration request message containing profile information associated with a terminal, and a receiver which receives a profile information registration response message from the profile information server corresponding to the profile information registration request message.

In still yet another general aspect, a profile information server includes a receiver which receives a profile information registration request message containing profile information associated with a terminal, a registration unit which registers the profile information based on the received profile information registration request message, and a transmitter which transmits a profile information registration response message corresponding to the profile information registration request message, based on the registration result.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an exemplary structure of a profile information updating system.

FIG. 2 is a diagram illustrating an exemplary method of updating profile information using a profile information agent.

FIG. 3 is a diagram illustrating an exemplary method of updating profile information using a gateway.

FIG. 4 is a diagram illustrating an exemplary method of updating profile information using a network server.

FIGS. 5A through 5C are diagrams illustrating an example of including a profile information transmission request message in a particular region of a Binding Update (BU) message according to an exemplary embodiment.

FIG. 6 is a block diagram illustrating an exemplary configuration of a profile information agent.

FIG. 7 is a block diagram illustrating an exemplary configuration of a gateway.

FIG. 8 is a block diagram illustrating an exemplary configuration of a network server.

FIG. 9 is a block diagram illustrating an exemplary configuration of a profile information server.

Throughout the drawings and the detailed description, unless otherwise described, the same drawing reference numerals will be understood to refer to the same elements, features, and structures.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, description of well-known functions and constructions are omitted to increase clarity and conciseness.

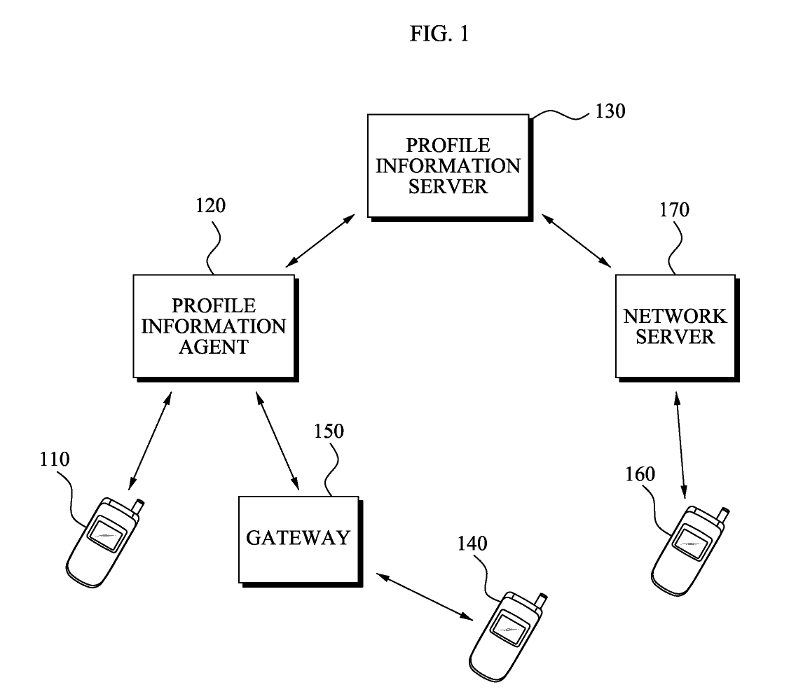

FIG. 1 illustrates an exemplary structure of a profile information updating system. As shown in FIG. 1, the profile information updating system comprises a profile information agent 120, a profile information server 130, a gateway 150, and a network server 170.

According to an aspect, profile information may comprise all information associated with a terminal or a user of the terminal. For example, the profile information may comprise at least one of authentication information associated with the terminal, charge information, Quality of Service (QoS) information associated with a service being used by the terminal, communication network information associated with a network of the terminal, and service preference information associated with a service being preferred by the terminal. According to an aspect, the charge information may include fee schedule information of the terminal.

According to an aspect, the profile information associated with the terminal may comprise information associated with an address of the terminal in each wireless network. Where the terminal is handed over from a first wireless network to a second wireless network, a transmission path of data being transmitted to the terminal may be changed. Specifically, data being directly transmitted from the first wireless network to the terminal may be transmitted from the first wireless network to the second wireless network. Also, the data may be transmitted from the second wireless network to the terminal. After the handover is completed, the data may be directly transmitted from the second wireless network to the terminal. In order to transmit the data from the first wireless network to the second wireless network, the second wireless network may need to be aware of information associated with an address of the terminal in the first wireless network.

So that the second wireless network may authenticate the terminal, the second wireless network may need to be aware of address information of the terminal in the first wireless network.

A terminal that is able to access a plurality of wireless networks may use a plurality of services provided in each wireless network. In the case of a voice call, the terminal may make the voice call using a Voice over Internet Protocol (VoIP) service being provided in a WLAN. The terminal may also use a voice call service being provided by a mobile phone network. According to an aspect, profile information may comprise a service preference of the terminal with respect to the VoIP service and the voice call service provided by the mobile phone network, and each network may provide the terminal with a corresponding service based on the service preference included in the profile information.

Information included in the profile information may be changed according to a selection of a user of the terminal. Once the changed profile information is updated, each network may reflect the changed profile information to provide the service. According to an aspect, as the profile information associated with the terminal is changed, the changed profile information may be dynamically updated in the profile information server 130.

The profile information server 130 may store profile information associated with the terminal accessing the network. Where the profile information is changed, the profile information server 130 may update the changed profile information. The network may provide an accessing terminal with an optimal service based on the profile information associated with the terminal stored in the profile information server 130. According to an aspect, Authentication, Authorization, and Accounting (AAA) server of a communication network may operate as the profile information server 130. The AAA server may include security information and authentication information associated with each terminal in profile information of a corresponding terminal and manage the profile information.

Where profile information associated with a particular terminal is not stored in the profile information server 130, the profile information server 130 may register profile information associated with the particular terminal according to a profile information registration request message. Where the profile information associated with the particular terminal is already registered, the profile information server 130 may update the registered profile information according to the profile information registration request message. A registration process and an update process may be the same, except for whether the profile information associated with the particular terminal is being stored for the first time. Accordingly, hereinafter, the terms “registration” and “update” may be used interchangeably.

Referring to FIG. 1, the profile information agent 120 may receive a profile information transmission request message from a terminal 110 or the gateway 150. In response to the received profile information transmission request message, the profile information agent 120 may transmit a profile information registration request message to the profile information server 130. Where the profile information server 130 successfully registers profile information, the profile information agent 120 may receive a profile information registration response message from the profile information server 130. According to an aspect, a home agent of a WLAN may operate as the profile information agent 120.

The gateway 150 may detect that profile information associated with a terminal 140 is changed, and transmit a profile information transmission request message to the profile information agent 120. The gateway 150 may receive a profile information transmission confirm message from the profile information agent 120, depending on whether registration of the profile information is successful. According to an aspect, an access router of the WLAN may operate as the gateway 150.

The network server 170 may detect that profile information of a terminal 160 is changed, and transmit a profile information registration request message to the profile information server 130. The network server 170 may receive a profile information registration confirm message from the profile information server 130 depending on whether registration of the profile information is successful. According to an aspect, a network access server or an AAA client of the WLAN may operate as the network server 170.

According to an aspect, where profile information associated with the terminal 110 or 140 is changed, the profile information agent 120 or the gateway 150 may detect the change in the profile information and update the changed profile information. The terminal 110 or 140 may not need to perform a separate procedure for updating the profile information. Accordingly, the profile information associated with the terminal 110 or 140 may be updated by minimizing change in a protocol associated with the terminal 110 or 140 and by changing only protocols of network devices such as the profile information agent 120, the gateway 150, and the network server 170.

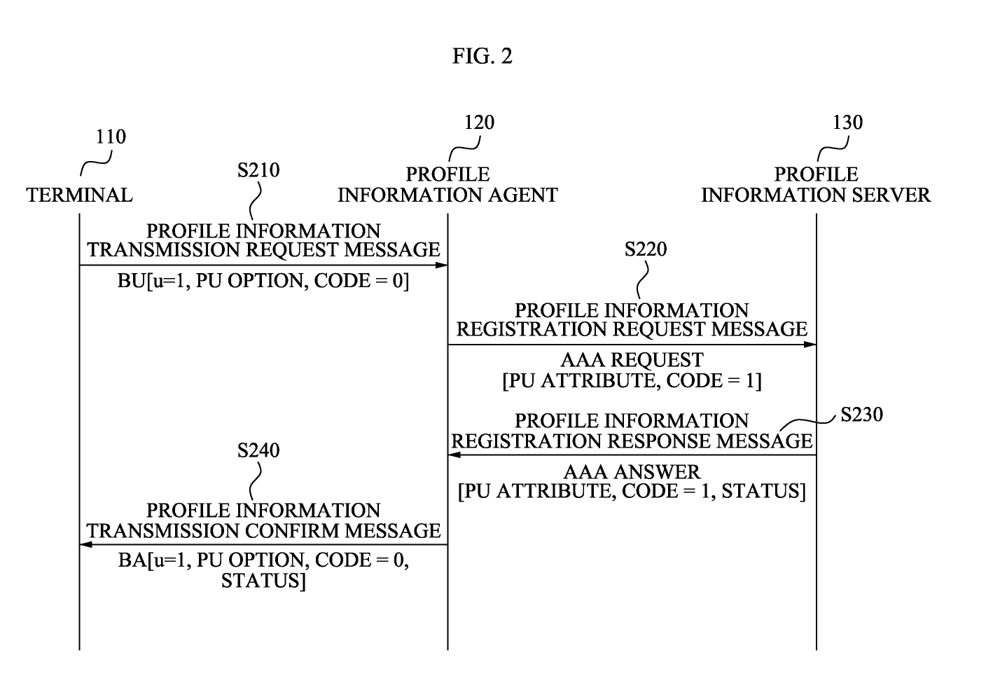

FIG. 2 illustrates an exemplary method of updating profile information using a profile information agent 120.

In operation S210, a terminal 110 may transmit a profile information transmission request message to the profile information agent 120. According to an aspect, the profile information transmission request message may include profile information. According to an aspect, the terminal 110 may use a Binding Update (BU) message to transmit the profile information transmission request message. The terminal 110 may set “U” bit in the BU message to “1”, indicating that the BU message includes the profile information. The terminal 110 may set a “code” region in the BU message to “0”, indicating that the entity transmitting the profile information transmission request message is the terminal 110. The terminal 110 may add, to the BU message, a Profile Update (PU) option including the profile information.

In operation S220, the profile information agent 120 may transmit a profile information registration request message to a profile server 130. According to an aspect, the profile information registration request message may include profile information. According to an aspect, the profile information agent 120 may use an AAA request message to transmit the profile information registration request message. The profile information agent 120 may add, to the AAA request message, a PU attribute including the profile information. The profile information agent 120 may set a “code” region of the AAA request message to “1”, indicating that the entity transmitting the AAA request message is the profile information agent 120.

The profile information server 130 may receive the profile information registration request message and extract the profile information in the received profile information registration request message. The profile information server 130 may register the extracted profile information.

In operation S230, the profile information server 130 may transmit a profile information registration response message to the profile information agent 120. According to an aspect, the profile information registration response message may include the same profile information as profile information actually registered by the profile information server 130. The profile information agent 120 may compare the profile information registered by the profile information server 130 with the profile information transmitted from the profile information agent 120 to the profile information server 130 and determine whether accurate profile information is registered based on the comparison result.

According to an aspect, the profile information server 130 may use an AAA answer message to transmit the profile information registration response message. The profile information server 130 may add, to the AAA answer message, a PU attribute including the profile information. The profile information server 130 may set a “code” region of the AAA answer message to “1”, indicating that the entity receiving the AAA answer message is the profile information server 130.

According to an aspect, the profile information server 130 may include the result of the profile information registration in the profile information registration response message and transmit the profile information registration confirm message. The profile information server 130 may use a “status” region of the AAA answer message to indicate whether registration of the profile information is a success.

In operation S240, the profile information agent 120 may transmit a profile information transmission confirm message to the terminal 110. According to an aspect, the profile information agent 120 may use a Binding Acknowledgement (BA) message to transmit the profile information transmission confirm message. The profile information agent 120 may add a PU option to the BA message. The profile information agent 120 may set a “code” region of the BA message to “0”, indicating that the entity receiving the BA message is the profile information agent 120.

FIG. 2 illustrates an example of starting a profile information update procedure by the terminal 110. The terminal 110 may transmit the profile information transmission request message and receive the profile information transmission confirm message. Accordingly, the terminal 110 according to an exemplary embodiment of FIG. 2 may need to support the update procedure described therewith in order to transmit and receive each message.

According to an aspect, a path from the terminal 110 to the profile information agent 120 and a path from the profile information agent 120 to the profile information server 130 may be cryptographic paths. Since a third party is not allowed to read profile information being transmitted via the cryptographic path, the profile information may be securely transmitted.

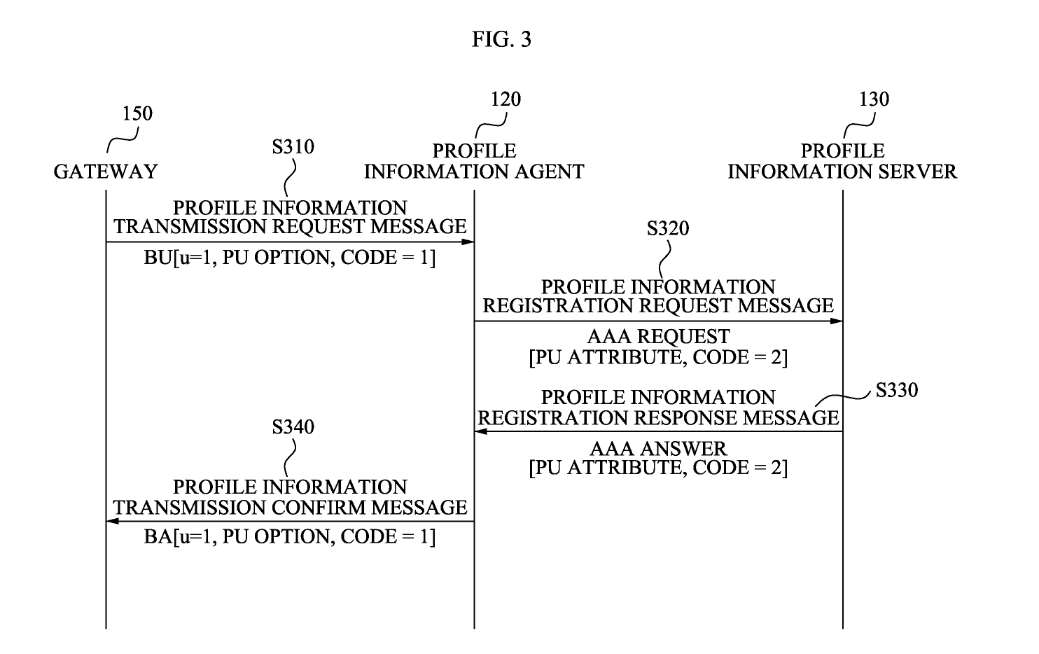

FIG. 3 illustrates an exemplary method of updating profile information using a gateway 150.

In operation S310, the gateway 150 may transmit a profile information transmission request message to a profile information agent 120. According to an aspect, the gateway 150 may use a BU message to transmit the profile information transmission request message. The gateway 150 may set “U” bit in the BU message to “1”, indicating that the BU message includes profile information. Also, the gateway 150 may set a “code” region in the BU message to “1”, indicating that the entity receiving the profile information transmission request message is the profile agent 120.

An operation of the profile information agent 120 in operation S320 and an operation of the profile information server 130 in operation S330 are similar to the operation of the profile information agent 120 and the operation of the profile information server 130 described with reference to FIG. 2. Therefore, further descriptions will be omitted.

In operation S340, the profile information agent 120 may transmit a profile information transmission confirm message to the gateway 150. According to an aspect, the profile information agent 120 may use a BA message to transmit the profile information transmission confirm message. The profile information agent 120 may add a PU option to the BA message. The profile information agent 120 may set a “code” region of the BA message to “1”, indicating that the entity transmitting the BA message is the profile information agent 120.

According to an aspect, a path from the gateway 150 to the profile information agent 120 and a path from the profile information agent 120 to the profile information server 130 may be cryptographic paths. Since a third party is not allowed to read profile information via the cryptographic path, profile information associated with the terminal 140 may be securely transmitted.

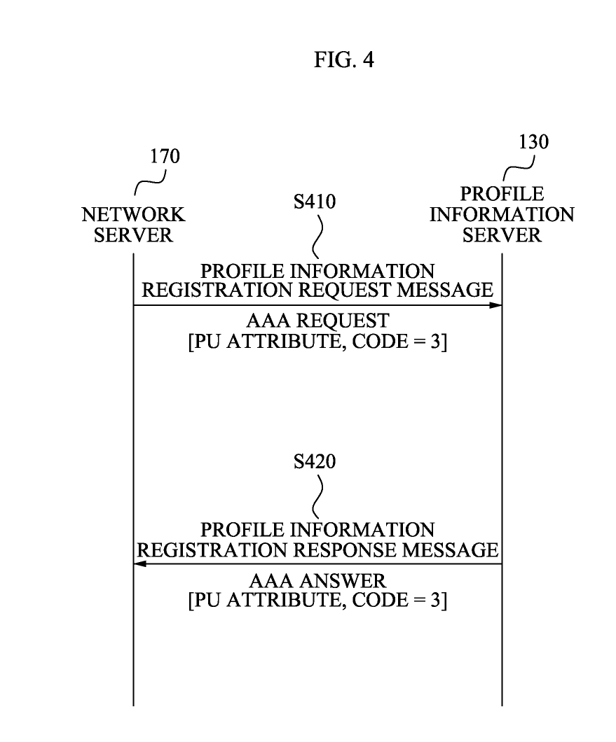

FIG. 4 illustrates an exemplary method of updating profile information using a network server 170.

Although not shown in FIG. 4, according to an aspect, the terminal 160 of FIG. 1 may transmit a profile information transmission request message to the network server 170. The profile information transmission request message may include changed profile information.

In operation S410, the network server 170 may transmit a profile information registration request message to a profile information server 130. According to an aspect, the network server 170 may use an AAA request message to transmit the profile information registration request message. The network server 170 may add a PU attribute to the AAA request message, including the changed profile information associated with the terminal 160. The network server 170 may set a “code” region of the AAA request message, indicating that the entity transmitting the AAA request message is the network server 170.

The profile information server 130 may receive the profile information registration request message and extract the profile information in the received profile information registration request message. The profile information server 130 may register the extracted profile information.

In operation S420, the profile information server 130 may transmit a profile information registration response message to the network server 170. According to an aspect, the profile information server 130 may use an AAA answer to transmit the profile information registration response message. The profile information server 130 may add a PU attribute to the AAA request message. The profile information server 130 may set a “code” region of the AAA answer message to “3”, indicating that the entity receiving the AAA answer message is the network server 170.

Although not shown in FIG. 4, according to an aspect, the network server 170 may transmit a profile information transmission confirm message to the terminal 160.

According to an aspect, a path from the terminal 160 to the network server 170 and a path from the network server 170 to the profile information server may be not cryptographic paths. Although profile information associated with the terminal 160 not supporting a cryptographic communication is changed, it is possible to update the profile information associated with the terminal 160.

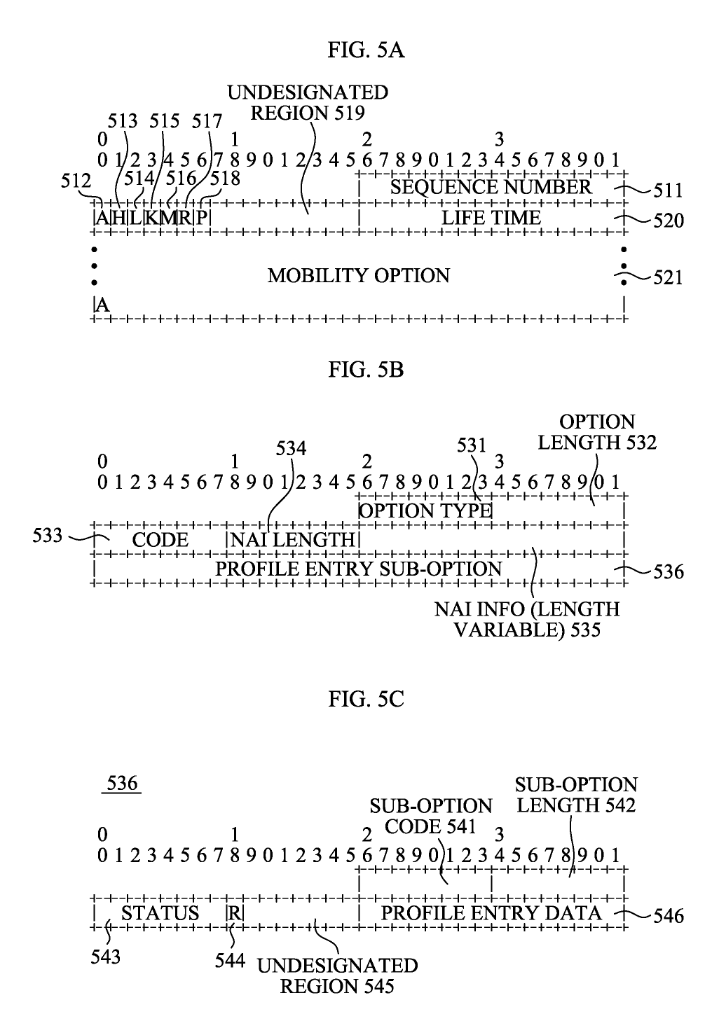

FIGS. 5A through 5C illustrate an example of including a profile information transmission request message in a particular region of a BU message according to an exemplary embodiment. Hereinafter, a data frame including the profile information transmission request message will be described with reference to FIGS. 5A through 5C.

FIG. 5A shows a data frame that includes the BU message. The BU message may include a sequence number 511, flags 512, 513, 514, 515, 516, 517, and 518, an undesignated region 519, a life time 520 of the BU message, and a mobility option 521.

According to an aspect, where the “R” flag 517 is “0”, a corresponding data frame may include the BU message. Where the “R” flag 517 is “1”, the corresponding data frame may include profile information.

According to an aspect, the terminal 110 or the gateway 150 of FIG. 1 may set the “R” flag 517 to “1” and transmit a profile information transmission request message containing profile information to the profile information agent 120.

FIG. 5B shows a structure of a data frame including profile information. The data frame may include an option type 531, an option length 532, a code 533, a NAI length 534, NAI information (length variable) 535, and a profile entry sub-option 536.

The option type 531 denotes type information of a PU option. According to an aspect, where profile information is included in the profile information transmission request message transmitted by the gateway 150, the option type 531 may have a value of “Profile-UPDATE-BY_MAG”.

The option length 532 denotes the length of the data frame shown in FIG. 5B.

The code 533 denotes the entity transmitting the data frame containing the profile information, or the entity receiving the data frame. According to an aspect, where the code 533 is “0”, the entity may be the terminal 110. Where the code 533 is “1”, the entity may be the profile information agent 120. Where the code is “2”, the entity may be the gateway 150. Where the code 533 is “3”, the entity may be the network server 170.

The NAI length 534 denotes the length of a network access identifier and the NAI information 535 denotes a value of the network access identifier.

The profile-entry sub-option 536 may include the profile information.

FIG. 5C shows an exemplary structure of the profile entry sub-option 536. The profile entry sub-option 536 may include a sub-option code 541, a sub-option length 542, a status 543, an “R” flag 544, an undesignated region 545, and profile entry data 546.

The sub-option code 541 denotes a property of data included in the profile entry sub-option 536.

The sub-option length 542 denotes the length of the profile entry sub-option 536.

The status 543 indicates whether registration of the profile information is successfully completed. According to an aspect, when the registration of the profile information is a success, the status 543 may have a value of “0”. Conversely, when the registration of the profile information is a failure, the status 543 may have a value grater than “0”. According to another aspect, the value of the status 543 may be determined based on a progress of a profile information registration procedure.

The “R” flag 544 may indicate whether the profile information is registered. According to an aspect, where the “R” flag 544 is “1”, i profile information registered in the profile information server 130 may be deleted. Where the “R” flag 543 is “0”, the profile information included in the data frame may be registered.

The profile entry data 546 includes profile information to be registered in the profile information server 130.

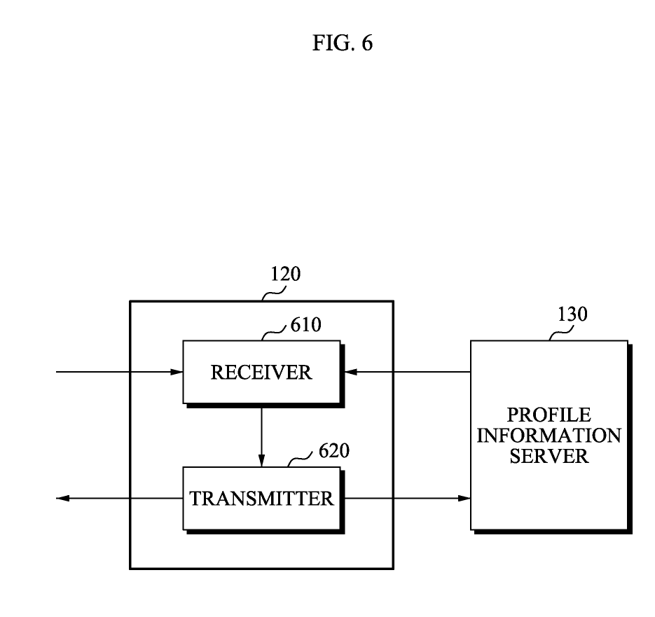

FIG. 6 illustrates an exemplary configuration of the profile information agent 120. Hereinafter, an operation of the profile information agent 120 will be described with reference to FIGS. 1 and 6. The profile information agent 120 comprises a receiver 610 and a transmitter 620.

The receiver 610 may receive a profile information transmission request message from the terminal 110. The profile information transmission request message may include profile information associated with the terminal 110. According to an aspect, the profile information transmission request message may be transmitted in a similar way to a BU message. A plurality of bits of which usages are undesignated may exist in a data frame including the BU message. According to an aspect, the plurality of bits of which the usages are undesignated may be used to transmit the profile information transmission request message.

According to an aspect, profile information may comprise at least one of authentication information associated with a terminal, charge information, QoS information, communication network information associated with a network of the terminal, and service preference information.

The transmitter 620 may extract the profile information included in the profile information transmission request message. The transmitter 620 may include the extracted profile information in a profile information registration request message, and transmit the profile information registration request message to the profile information server 130. According to an aspect, the profile information registration request message may be transmitted in a similar way to an AAA request message. Also, a particular bit of the AAA request message may be used for transmitting the profile information registration request message.

In response to the profile information registration request message, the receiver 610 may receive a profile information registration response message from the profile information server 130. The profile information registration response message may include information regarding whether registration of the profile information is a success, and profile information actually registered by the profile information server 130. The profile information agent 120 may determine whether registration of the profile information is a success. Also, the profile information agent 120 may receive the profile information actually registered by the profile information server 130 to determine whether accurate profile information is registered.

According to an aspect, the transmitter 620 may transmit a profile information transmission confirm message to the terminal 110 in response to the profile information registration confirm message.

According to an aspect, the receiver 610 may receive a profile information transmission request message from the terminal 110 using a cryptographic protocol. The profile information transmission request message may include profile information. The profile information may comprise terminal authentication information and the like that may cause a problem when it is exposed to a third party. Where the profile information transmission request message is received from the terminal 110 using the cryptographic protocol, the receiver 610 may securely receive the terminal authentication information.

According to an aspect, the receiver 610 may receive the profile information transmission request message using an Internet Protocol Security (IPSec) protocol. IPSec corresponds to an Internet standard scheme for protecting an IP packet of a network layer and also denotes a set of security protocols and code algorithms that may support integrity, authentication, and a confidential security service of the IP packet in a security-vulnerable Internet network. Also, IPSec is a communication protocol that may realize secure communication in the security-vulnerable Internet. Also, IPSec is a communication protocol that may prevent an available virtual exclusive line such as an exclusive line on the Internet line, preventing a malicious behavior such as overhearing data.

According to an aspect, the transmitter 620 may transmit a profile information registration request message to the profile information server 130 using a cryptographic protocol. The profile information registration request message may include profile information. The profile information includes information that may cause a problem when it is exposed to a third party. Where the profile information registration request message containing the profile information is transmitted using the cryptographic protocol, the transmitter 620 may securely transmit terminal authentication information.

According to an aspect, the transmitter 620 may securely transmit profile information using a protocol. The protocol may use a cryptographic key. According to an aspect, the transmitter 620 may encrypt the profile information using the cryptographic key and transmit the encrypted profile information. The profile information server 130 may receive the encrypted profile information and extract the profile information using the cryptographic key. Since the third party that is unaware of the cryptographic key is not allowed to extract the profile information, the transmitter 620 may securely transmit the profile information.

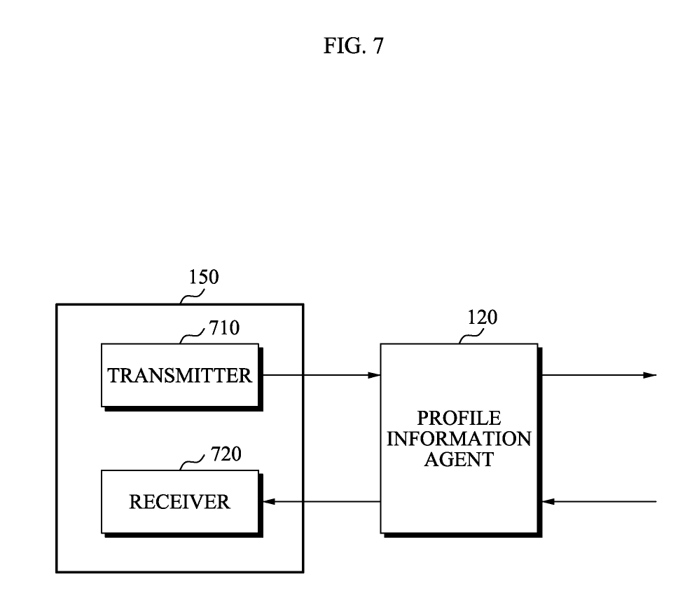

FIG. 7 illustrates an exemplary structure of the gateway 150. Hereinafter, an operation of the gateway 150 will be described with reference to FIGS. 1 and 7. The gateway 150 comprises a transmitter 710 and a receiver 720.

The transmitter 710 may transmit a profile information transmission request message to the profile information agent 120. The profile information transmission request message may include profile information associated with a terminal.

According to an aspect, the profile information may comprise at least one of authentication information associated with a terminal, charge information, QoS information, communication network information associated with a network of the terminal, and service preference information.

According to an aspect, the transmitter 710 may transmit the profile information transmission request message to the profile information agent 120 using a cryptographic protocol. The profile information transmission request message may include information, such as terminal authentication information and the like, that may cause a problem when the information is exposed to a third party. The transmitter 710 may securely transmit profile information using the cryptographic protocol.

According to an aspect, the transmitter 710 may transmit the profile information transmission request message using an IPSec protocol.

In response to the profile information transmission request message, the receiver 720 may receive a profile information transmission confirm message from the profile information agent 130. The profile information transmission confirm message may include profile information registered by the profile information server 130. The receiver 720 may compare the profile information registered by the profile information server 130 with the profile information included in the profile information transmission request message and determine whether accurate information is registered based on the comparison result.

According to an aspect, a determination unit (not shown) may be further provided. The determination unit may determine whether profile information associated with the terminal 140 is updated. Where the terminal 140 is handed over from a first wireless network to a second wireless network, the second wireless network may authenticate the terminal 140. The terminal 140 may transmit the profile information to the second wireless network in order to be authenticated in the second wireless network.

According to an aspect, the terminal 140 may transmit the profile information to the gateway 150. The gateway 150 may transmit the profile information associated with the terminal 140 to an AAA server of the second wireless network.

Since the gateway 150 is aware of the profile information associated with the terminal 140, the determination unit may determine whether the profile information associated with the terminal 140 is changed. Where the profile information is changed, the transmitter 710 may transmit a profile information transmission request message to the profile information agent 120.

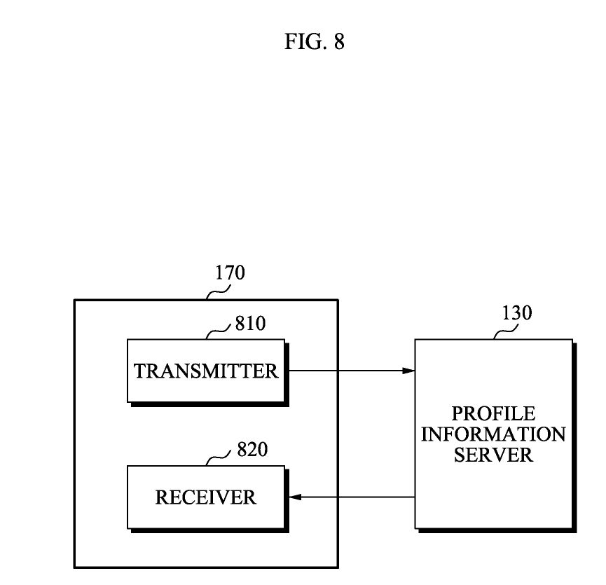

FIG. 8 illustrates an exemplary configuration of a network server 170. Hereinafter, an operation of the network server 170 will be described with reference to FIGS. 1 and 8. The network server 170 comprises a transmitter 810 and a receiver 820.

The transmitter 810 may transmit a profile information registration request message to the profile information server 130. The profile information registration request message may include profile information associated with the terminal 160.

According to an aspect, the profile information may comprise at least one of authentication information associated with a terminal, charge information, QoS information, communication network information associated with a network of the terminal, and service preference information.

In response to the profile information registration request message, the receiver 820 may receive a profile information registration response message from the profile information server 130.

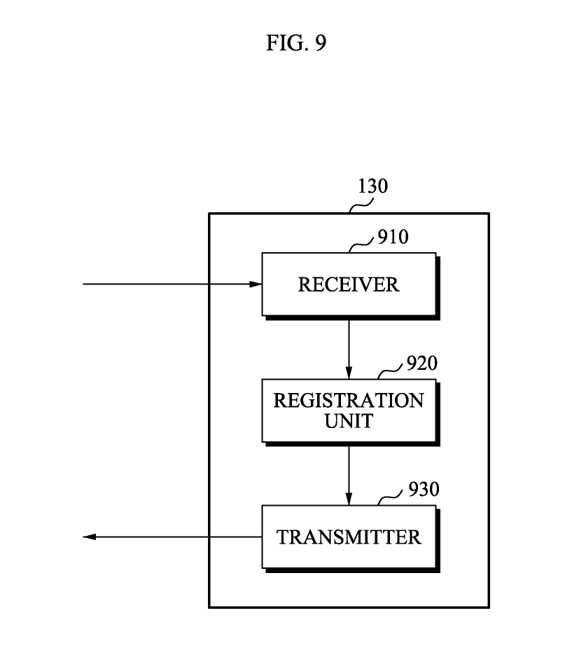

FIG. 9 illustrates an exemplary configuration of the profile information server 130. Hereinafter, an operation of the profile information server 130 will be described with reference to FIG. 9. The profile information server 130 comprises a receiver 910, a registration unit 920, and a transmitter 930.

The receiver 910 may receive a profile information registration request message. The profile information registration request message may include profile information associated with a terminal. According to an aspect, the profile information may comprise at least one of authentication information associated with the terminal, charge information, QoS information, communication network information associated with a network of the terminal, and service preference information.

According to an aspect, the receiver 920 may receive the profile information registration request message from the profile information agent 120 or the network server 170.

The profile information may comprise terminal authentication information and the like that may cause a problem when it is exposed to a third party. The receiver 910 may receive the profile information registration request message containing the profile information, using a cryptographic protocol.

The registration unit 920 may register the profile information of the terminal based on the received profile information registration request message. According to an aspect, various types of networks associated with a corresponding terminal may transmit a reference request message associated with the registered profile information. In response to the reference request message, the profile server 130 may provide profile information for the networks. Each network may provide an appropriate service for the corresponding terminal by referring to the profile information.

Based on a registration result of the registration unit 920, the transmitter 930 may transmit a profile information registration confirm message in response to the profile information registration request message. According to an aspect, the transmitter 930 may transmit the profile information registration confirm message to the profile information agent 120 or the network server 170.

According to an aspect, the profile information registration confirm message may include profile information actually registered by the registration unit 920. The profile information agent 120 or the network server 170 may receive the profile information registration confirm message and determine whether accurate profile information is transmitted based on the profile information included in the profile information registration confirm message.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A profile information agent comprising:
a receiver which receives a profile information transmission request message containing profile information associated with a terminal; and
a transmitter which transmits a profile information registration request message to a profile information server, the profile information registration request message including the profile information,
wherein the receiver receives a profile information registration response message from the profile information server corresponding to the profile information registration request message.

2. The profile information agent of claim 1, wherein the profile information comprises at least one of authentication information associated with the terminal, charge information, Quality of Service (QoS) information, communication network information associated with a network of the terminal, and service preference information.

3. The profile information agent of claim 1, wherein the transmitter transmits a profile information transmission confirm message to the terminal corresponding to the profile information registration response message.

4. The profile information agent of claim 1, wherein the receiver receives the profile information transmission request message using a cryptographic protocol.

5. The profile information agent of claim 4, wherein the cryptographic protocol is an Internet Protocol Security (IPSec) protocol.

6. The profile information agent of claim 1, wherein the transmitter transmits the profile information registration request message using a cryptographic protocol.

7. The profile information agent of claim 6, wherein the cryptographic protocol uses a cryptographic key.

8. A gateway comprising:
a transmitter which transmits, to a profile information agent, a profile information transmission request message containing profile information associated with a terminal; and
a receiver which receives a profile information transmission confirm message from the profile information agent corresponding to the profile information transmission request message.

9. The gateway of claim 8, wherein the profile information comprises at least one of authentication information associated with the terminal, charge information, QoS information, communication network information associated with a network of the terminal, and service preference information.

10. The gateway of claim 8, wherein the transmitter transmits the profile information transmission request message using a cryptographic protocol.

11. The gateway of claim 10, wherein the cryptographic protocol is an IPSec protocol.

12. A network access server comprising:
a transmitter which transmits, to a profile information server, a profile information registration request message containing profile information associated with a terminal; and
a receiver which receives a profile information registration response message from the profile information server corresponding to the profile information registration request message.

13. The network access server of claim 12, wherein the profile information comprises at least one of authentication information associated with the terminal, charge information, QoS information, communication network information associated with a network of the terminal, and service preference information.

14. A profile information server comprising:
a receiver which receives a profile information registration request message containing profile information associated with a terminal;
a registration unit which registers the profile information based on the received profile information registration request message; and
a transmitter which transmits a profile information registration response message corresponding to the profile information registration request message, based on the registration result.

15. The profile information server of claim 14, wherein the profile information comprises at least one of authentication information associated with the terminal, charge information, QoS information, communication network information associated with a network of the terminal, and service preference information.
